(19) United States
(12) Patent Application Publication
(10) Pub. No.: US 2016/0082520 A1
(43) Pub. Date: Mar. 24, 2016

(54) BORING DEVICE

(71) Applicant: HYUNDAI MOTOR COMPANY, Seoul (KR)

(72) Inventor: Tae Jin KIM, Ulsan (KR)

(21) Appl. No.: 14/565,128

(22) Filed: Dec. 9, 2014

(30) Foreign Application Priority Data
Sep. 22, 2014 (KR) 10-2014-0125771

(51) Int. Cl. B23B 29/034

(52) U.S. Cl. CPC B23B 29/03417; B23B 2222/04; B23B 2229/04

(57) ABSTRACT

A boring device includes a case configured to be provided with a hole machining part; a boring tool configured to be inserted into the hole machining part; and a spin member configured to be detachably provided from the boring tool and rotate the boring tool. The boring tool is made of an aluminum material and thus has a reduced weight to reduce load of the spin member so as to machine the hole of the case even when a separate guide pad is not applied to the boring tool. This minimizes cost and improves quality, and the boring tool corresponding to the hole is provided at the time of machining the hole, thereby improving grinding workability and marketability.

### CROSS-REFERENCE TO RELATED APPLICATION

This application is based on and claims the benefit of priority to Korean Patent Application No. 10-2014-0125771, filed on Sep. 22, 2014 in the Korean Intellectual Property Office, the disclosure of which is incorporated herein in its entirety by reference.

### TECHNICAL FIELD

The present disclosure relates to a boring device, and more particularly, to a boring device capable of reducing load of a spin member by reducing weight of a boring tool, machining holes of a case even when a separate guide pad is not applied to the boring tool, and improving grinding workability by providing each boring tool corresponding to the holes at the time of machining the holes.

### BACKGROUND

Generally, a boring device is used for a boring operation which functions to expand a hole previously machined by drilling, forging, casting, or the like, and finish, complete, and machine the inside of the hole.

A process of machining a cylinder head and block of an engine includes machining a hole of the cylinder. In this case, the boring device is used to machine the hole.

According to the related art, a guide pad is formed on an outer peripheral surface of the boring device to adhere a guide pad of the boring device to the hole of the case at the time of machining the hole of the case to support cutting pressure, thereby preventing the tool from being bent.

However, the boring device according to the related art is made of a steel material and therefore is above a weight limit so as to apply a load to a spin member rotating the boring device and thereby increase the risk of failure Also the guide pad always has a predetermined thickness on the outer peripheral surface thereof, which thereby increases cost and manufacturing time.

### SUMMARY

The present disclosure has been made to solve the above-mentioned problems occurring in the prior art while advantages achieved by the prior art are maintained intact.

An aspect of the present disclosure provides a boring device capable of reducing load of a spin member by reducing weight of a boring tool, machining holes of a case even when a separate guide pad is not applied to the boring tool, and improving grinding workability by providing each boring tool corresponding to the holes at the time of machining the holes.

According to an exemplary embodiment of the present disclosure, a boring device includes a case configured to be provided with a hole machining part; a boring tool configured to be inserted into the hole machining part; and a spin member configured to be detachably provided from the boring tool and rotate the boring tool.

The boring tool may be made of an aluminum material.

The hole of the case may include a front main bore, a rear main bore, an output shaft bore, and a differential bore which are formed in the case.

The boring tool may include a front main bore boring tool, a rear main bore boring tool, an output shaft bore boring tool, and a differential bore boring tool which correspond to the front main bore, the rear main bore, the output shaft bore, and the differential bore.

An outer peripheral surface of the boring tool may be provided with a fine adjustment part to change the outer diameter of the boring tool.

The fine adjustment part may include: a taper spacer configured to be formed inside the boring tool; a sheet configured to be provided outside the boring tool provided with the taper spacer; and a screw configured to fix the sheet.

One end of the boring tool may be provided with an adapter coupled with the spin member.

The outer peripheral surface of the adapter may be provided with a balancing hole adjusting balance of the boring tool.

The balancing hole may be formed by drilling after the boring tool is coupled with the spin member.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a boring device according to an exemplary embodiment of the present disclosure;

FIGS. 2A and 2B are diagrams illustrating a hole formed in a case in the boring device according to the exemplary embodiment of the present disclosure;

FIG. 3 is a diagram illustrating a front main bore boring tool in the boring device according to the exemplary embodiment of the present disclosure;

FIG. 4 is a diagram illustrating a rear main bore boring tool in the boring device according to the exemplary embodiment of the present disclosure;

FIG. 5 is a diagram illustrating an output shaft bore boring tool in the boring device according to the exemplary embodiment of the present disclosure;

FIG. 6 is a diagram illustrating a differential boring tool in the boring device according to the exemplary embodiment of the present disclosure;

FIGS. 7 A and 7B are is a diagrams illustrating a fine adjustment part formed in the boring tool in the boring device according to the exemplary embodiment of the present disclosure; and

FIG. 8 is a cross-sectional view illustrating the fine adjustment part in the boring device according to the exemplary embodiment of the present disclosure.

### DETAILED DESCRIPTION

Exemplary embodiments of the present disclosure will be described in detail with reference to the accompanying drawings.

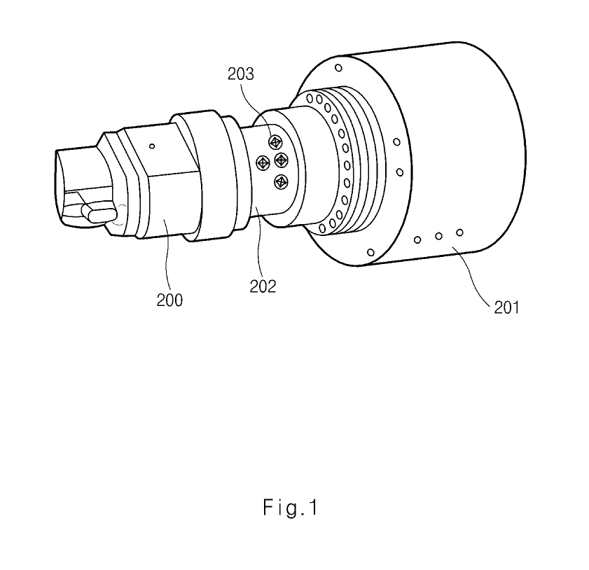

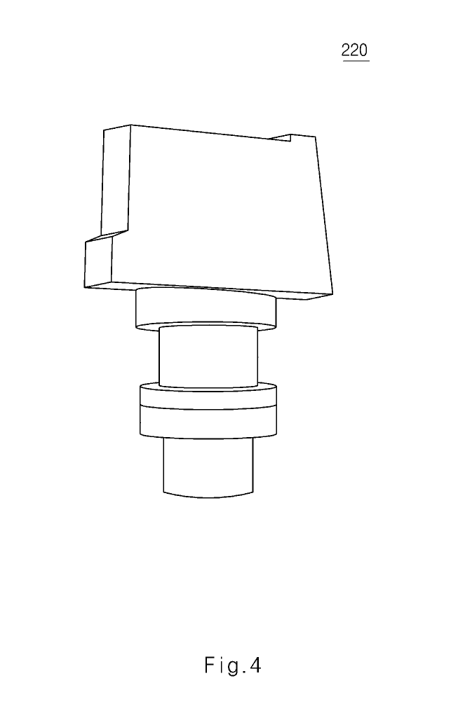

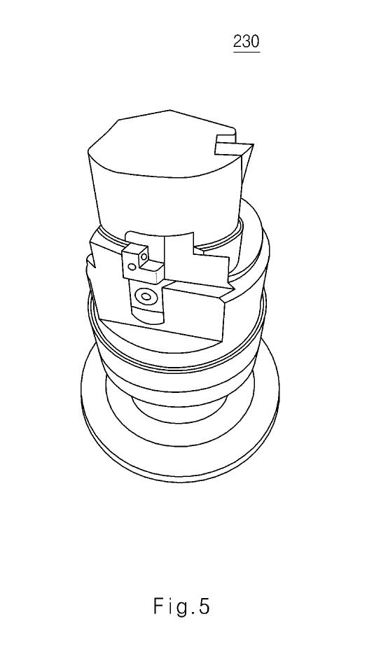

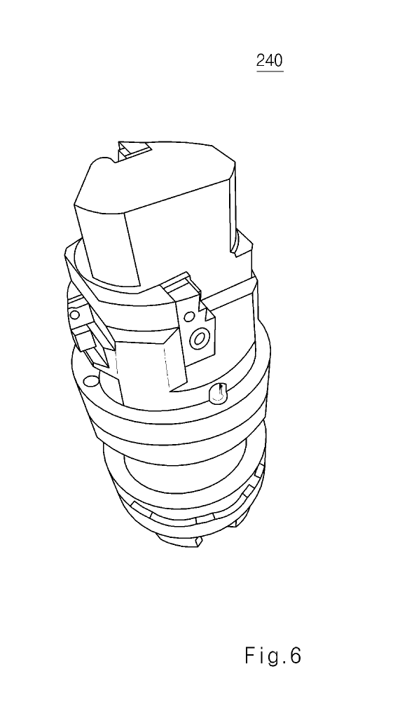

As illustrated in FIGS. 1 to 8, a boring device according to an exemplary embodiment of the present disclosure includes a case 100 in which a hole machining part is formed, a boring tool 200 inserted into the hole machining part, and a spin member 201 rotating the boring tool 200.

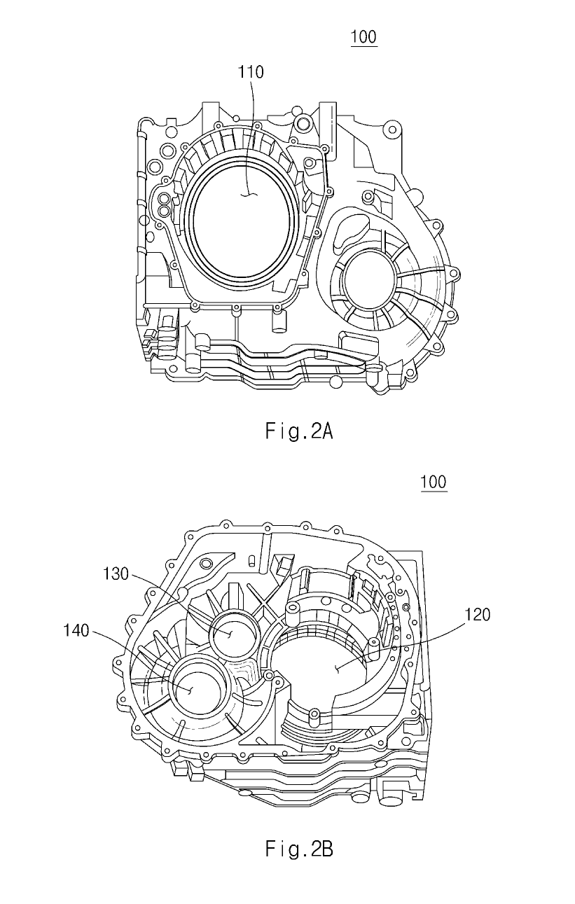

As illustrated in FIGS. 1 and 2, the boring tool 200 is rotatably provided by the spin member 201 and is inserted into the hole machining part of the case 100 to machine an inner diameter portion of the hole.

In this case, according to the exemplary embodiment of the present disclosure, the boring tool 200 is applied to machine the hole of the case 100 and may be preferably configured to be applied to all the cases requiring hole machining.

The spin member 201 is configured to generate rotation power to rotate the boring tool 200, and an end thereof is inserted with the boring tool 200 to machine the hole of the case 100 by rotating the boring tool 200.

Meanwhile, the spin member 201 and the boring tool 200 are provided to be detached from each other and may be configured to perform different machining depending on the kind of holes of the case 100.

The case 100 is inserted with a clutch, an input shaft, a carrier, an output shaft, and a differential gear and is provided with a plurality of holes through which the components may be connected to other parts.

As illustrated FIGS. 2A and 2B, holes of the case 100 include a front main bore 110 into which the clutch and the input shaft are inserted, a rear main bore 120 into which the carrier is inserted, an output shaft bore 130 into which the output shaft is inserted, and a differential bore 140 into which the differential gear is inserted.

Further, the boring tool 200 may be provided in plural so as to correspond to a plurality of holes.

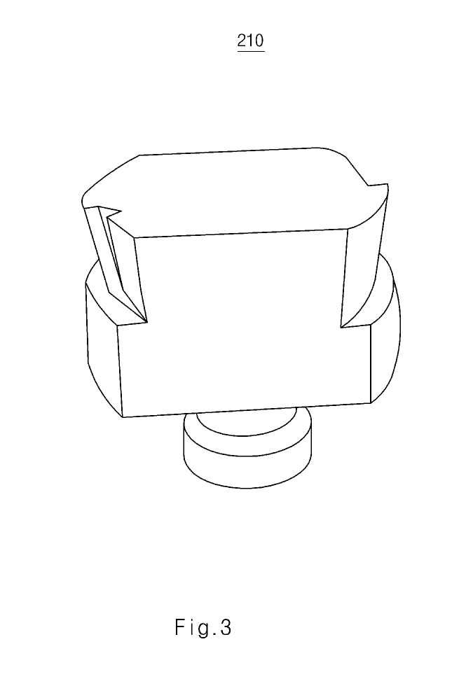

That is, as illustrated in FIGS. 3 to 6, the boring tool 200 includes a front main bore boring tool 210, a rear main bore boring tool 220, an output shaft bore boring tool 230, and a differential bore boring tool 240, which correspond respectively to the front main bore 110, the rear main bore 120, the output shaft bore 130, and the differential bore 140, to provide the boring tool fitting the hole of the case 100 at the time of machining the hole of the case 100, thereby improving grinding workability.

Meanwhile, the boring tool 200 according to the exemplary embodiment of the present disclosure is made of an aluminum material and thus has reduced weight compared to that of the existing boring tool made of a steel material so as to reduce the load of the spin member 201 rotating the boring tool 200. Thereby, the hole of the case 100 may be machined even when the separate guide pad is not applied to the boring tool 200, minimizing cost and improving quality.

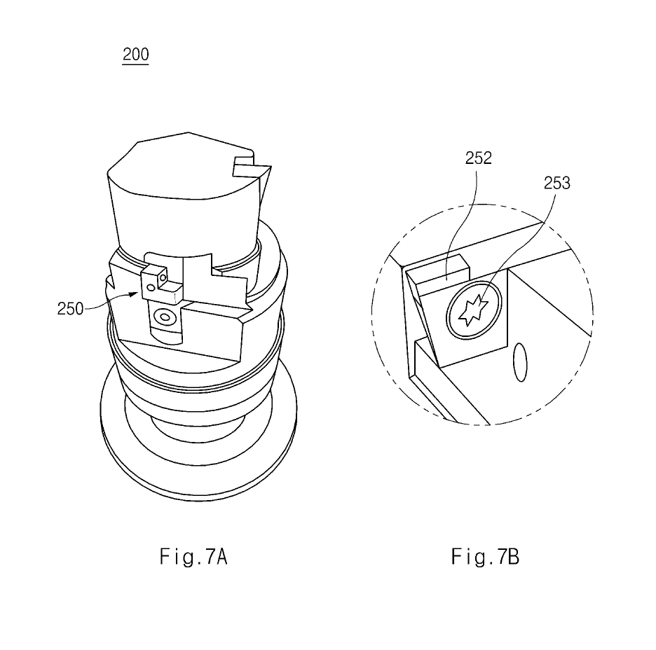

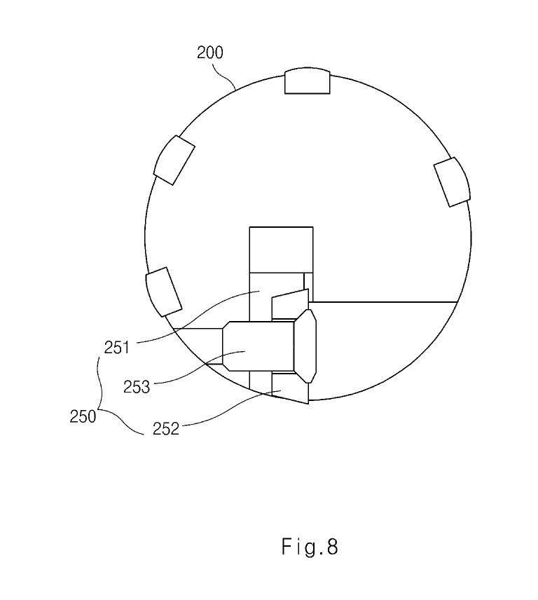

Further, as illustrated in FIGS. 7 and 8, an outer peripheral surface of the boring tool 200 is provided with a fine adjustment part 250 to vary the outer diameter of the boring tool 200.

In this case, the fine adjustment part 250 includes a taper spacer 251 which is formed inside the boring tool 200, a sheet 252 which is provided outside the boring tool 200 provided with the taper spacer 251, and a screw 253 fixing the sheet 252.

That is, the taper spacer 251 provided inside the boring tool 200 and the sheet 252 provided outside the boring tool 200 may be tightened or untightened by the screw 253 to move the sheet 252 so as to change the outer diameter of the boring tool 200, and thus at the time of occurrence of errors between the hole and the boring tool 200 during the machining of the hole of the case 100, the outer diameter may be adjusted by the fine adjustment part 250, thereby improving workability and accuracy.

As illustrated in FIG. 1, one end of the boring tool 200 is provided with an adapter 202 coupled with the spin member 201 to connect the boring tool 200 to the spin member 201.

In this case, an outer peripheral surface of the adapter 202 is preferably provided with a balancing hole 203 adjusting balance of the boring tool 200 to maintain balance at the time of rotating the boring tool 200 by the spin member 201.

Further, the balancing hole 203 may be easily formed by drilling even after the spin member 201 is coupled with the boring tool 200 by the adapter 202 of the boring tool 200 made of an aluminum material, thereby improving working force of the boring tool 200 by a simple method.

As described above, according to the exemplary embodiment of the present disclosure, the boring device is configured to include a boring tool 200 made of an aluminum material which is inserted into the hole machining part of the case 100 and the spin member 201 detachably provided from the boring tool 200 to rotate the boring tool 200. Thereby, the boring tool 200 has reduced weight comparpared to that of the existing boring tool to reduce load of the spin member 201. This enables machining of the hole of the case 100 even when a separate guide pad is not applied to the boring tool 200. This minimizes cost and improves quality. The boring tool 200 corresponding to the hole at the time of machining the hole is provided, thereby improving grinding workability and marketability.

As described above, according to the exemplary embodiments of the present disclosure, it is possible to minimize cost and improve quality of machining a hole even when a separate guide pad is not applied to the boring tool, and to enhancing marketability by improving grinding workability by providing the boring tool corresponding to the hole at the time of machining the hole, and by forming the boring tool of an aluminum material to reduce weight of the boring tool and reduce load of the spin member.

As described above, although the present disclosure has been described with reference to exemplary embodiments and the accompanying drawings, it would be appreciated by those skilled in the art that the present disclosure is not limited thereto but various modifications and alterations might be made without departing from the scope defined in the following claims.

What is claimed is:

1. A boring device, comprising:
a case configured to be provided with a hole machining part;
a boring tool configured to be inserted into the hole machining part; and
a spin member configured to be detachably provided from the boring tool and rotate the boring tool.

2. The boring device according to claim 1, wherein the boring tool is made of an aluminum material.

3. The boring device according to claim 1, wherein the hole of the case includes at least one of a front main bore, a rear main bore, an output shaft bore, and a differential bore formed in the case.

4. The boring device according to claim 2, wherein the boring tool includes a front main bore boring tool, a rear main bore boring tool, an output shaft bore boring tool, and a differential bore boring tool which correspond respectively to the front main bore, the rear main bore, the output shaft bore, and the differential bore.

5. The boring device according to claim 4, wherein an outer peripheral surface of the boring tool is provided with a fine adjustment part to change an outer diameter of the boring tool.

6. The boring device according to claim 5, wherein the fine adjustment part includes:
a taper spacer configured to be formed inside the boring tool;
a sheet configured to be provided outside the boring tool provided with the taper spacer; and
a screw configured to fix the sheet.

7. The boring device according to claim 2, wherein one end of the boring tool is provided with an adapter coupled with the spin member.

8. The boring device according to claim 7, wherein an outer peripheral surface of the adapter is provided with a balancing hole adjusting a balance of the boring tool.

9. The boring device according to claim 8, wherein the balancing hole is formed by drilling after the boring tool is coupled with the spin member.
